(19) United States
(12) Patent Application Publication
(10) Pub. No.: US 2011/0273527 A1
(43) Pub. Date: Nov. 10, 2011

(54) Electronic Infrared Wide-Angle and Safety-Promotion External Vehicular Back Mirror

(76) Inventor: Tzu-Chuan Liu, Taipei (TW)

(21) Appl. No.: 12/775,372

(22) Filed: May 6, 2010

(51) Int. Cl. H04N 7/00

(52) U.S. Cl. 348/36; 348/E05.024

(57) ABSTRACT

An electronic infrared wide-angle and safety-promotion external vehicular back mirror comprises a light-permeable reflective glass arranged inside a back mirror casing, a liquid crystal display attached to the backside of the light-permeable reflective glass, an infrared wide-angle camera, a detector, a light-emitting device, and a control circuit electrically connected to the abovementioned components. The camera, detector and light-emitting device are arranged at the perimeter of the casing. When the vehicle runs normally, the light-permeable reflective glass reflects general pictures of the rear side. The liquid crystal display is triggered by the direction light or a setting switch to present the physical image of the rear side, whereby the driver can directly observe the status of the rear side. Further, when the detector detects an abnormality, the control circuit triggers flashes and sounds to warn the driver. Thereby is eliminated the blind spot of the back mirror and promoted driving safety.

### BACKGROUND OF THE INVENTION

1. Field of the Invention

The present invention relates to an electronic infrared wide-angle and safety-promotion external vehicular back mirror, particularly to a back mirror structure, which is triggered by a setting switch or the direct light when the vehicle is driven straight ahead or turned left/right to present the physical image of the rear side on LCD, and which can detect an abnormality and warn the driver with flashes and sounds, whereby is eliminated the blind spot of the back mirror, and whereby is promoted driving safety.

2. Description of the Related Art

When a driver intends to turn left or right, he ordinarily observes the status of the left or right rear side with the back mirror at the left or right side of the vehicle in addition to switching on the left or right direction light. However, the conventional back mirror has blind spots and is hard to present the entire field of the rear side. Besides, there is no back mirror functioning like a reverse radar in the market. Thus, a driver must risk many dangers when he changes the driving lane. In turning a vehicle, poor vision of the back mirror may cause a traffic accident. Therefore, the conventional back mirror has room to improve. Based on many years' experience in the related field, the Inventor has been devoted to improving the back mirror structure and thus proposes the present invention. The Inventor expects that the present invention can outperform the conventional back mirror and promote driving safety.

### SUMMARY OF THE INVENTION

The primary objective of the present invention is to provide an electronic infrared wide-angle and safety-promotion external vehicular back mirror, which is triggered by a setting switch or the direct light during driving a vehicle straight ahead or turning the direction of the vehicle to present the physical image of the rear side on the LCD of the back mirror, and which can detect abnormalities and warn the driver with flashes or sounds, whereby is eliminated the blind spot of the back mirror and promoted driving safety.

The electronic infrared wide-angle and safety-promotion external vehicular back mirror of the present invention comprises a light-permeable reflective glass arranged inside a back mirror casing, a liquid crystal display attached to the backside of the light-permeable reflective glass, an infrared wide-angle camera, a detector, a first light-emitting device, and a control circuit electrically connected to the abovementioned components. The infrared wide-angle camera, detector and first light-emitting device are arranged at the perimeter of the casing. When the vehicle runs in a normal state, the light-permeable reflective glass functions like the conventional back mirror and reflects general pictures of the rear side. When the vehicle turns left or right, or when the driver turns on a setting switch in driving straight ahead, the liquid crystal display, infrared wide-angle camera and detector are turned on. The liquid crystal display presents the physical image of the corresponding rear side on the light-permeable reflective glass, and the driver can thus directly observe the status of the corresponding rear side. Further, when the detector detects an abnormality, the control circuit triggers flashes and sounds to warn the driver. Thereby is eliminated the blind spot of the back mirror and promoted driving safety.

### BRIEF DESCRIPTION OF THE DRAWINGS

FIG. 1 is a perspective view schematically showing a back mirror according to one embodiment of the present invention;

FIG. 2 is a perspective exploded view schematically showing a back mirror according to one embodiment of the present invention;

FIG. 3 is a block diagram schematically showing the circuit of a back mirror according to one embodiment of the present invention;

FIG. 4 is an assembly drawing of a back mirror according to one embodiment of the present invention; and

FIG. 5 and FIG. 6 are diagrams schematically showing the operations of a back mirror according to one embodiment of the present invention.

### DETAILED DESCRIPTION OF THE INVENTION

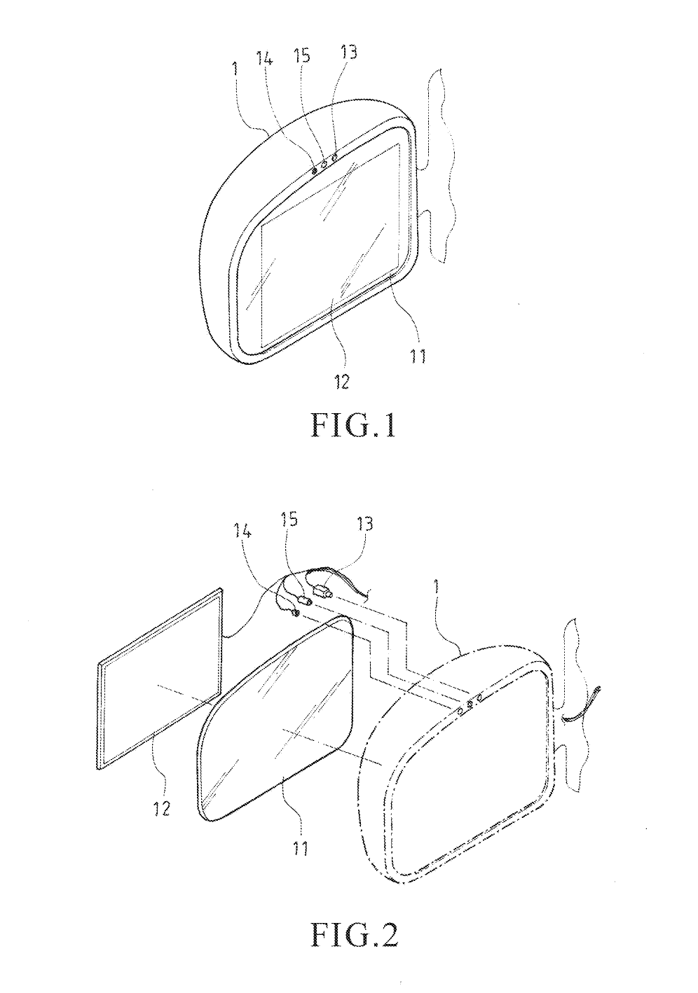

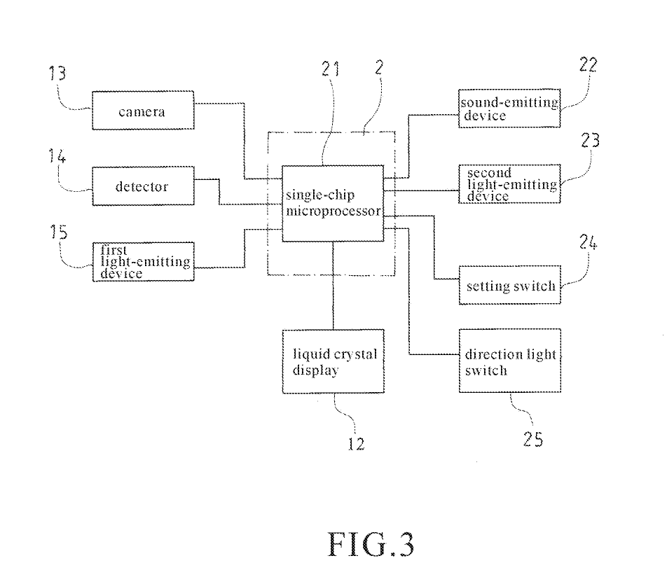

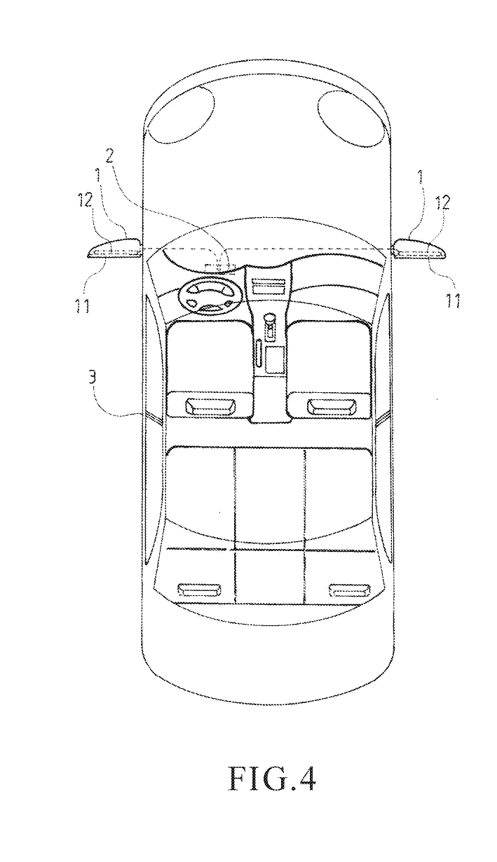

Refer to FIGS. 1-3. FIG. 1 and FIG. 2 are respectively a perspective view and a perspective exploded view schematically showing a back mirror according to one embodiment of the present invention. FIG. 3 is a block diagram schematically showing the circuit of a back mirror according to one embodiment of the present invention. The back mirror of the present invention comprises a light-permeable reflective glass 11 arranged inside a back mirror casing 1, a liquid crystal display 12 attached to the backside of the light-permeable reflective glass 11, a miniature infrared wide-angle camera 13, a detector 14 (such as an infrared or ultrasonic detector), a first light-emitting device 15 containing light-emitting diodes respectively emitting different colors of lights, and a control circuit 2 arranged at a control panel inside a vehicle and electrically connected to the liquid crystal display 12, infrared wide-angle camera 13, detector 14 and first light-emitting device 15, wherein the infrared wide-angle camera 13, detector 14 and first light-emitting device 15 are arranged at the perimeter of the casing 1. In this embodiment, the infrared wide-angle camera 13, detector 14 and first light-emitting device 15 are all arranged at the upper edge of the back mirror casing 1.

The control circuit 2 has a single-chip microprocessor 21, and a control program is written into the single-chip microprocessor 21 beforehand. The single-chip microprocessor 21 is electrically connected to the infrared wide-angle camera 13 and the detector 14 to receive image signals and detection signals. The single-chip microprocessor 21 is also electrically connected to the liquid crystal display 12 and the first light-emitting device 15. The single-chip microprocessor 21 is further electrically connected to a sound-emitting device 22 (such as a buzzer or speaker) and a second light-emitting device 23 containing light-emitting diodes respectively emitting different colors of lights. The sound-emitting device 22 and second light-emitting device 23 are arranged inside the vehicle. The control terminal of the single-chip microprocessor 21 is electrically connected to a setting switch 24 and a direction light switch 25, which is originally installed in the vehicle.

When the vehicle runs in a normal state, the liquid crystal display 12 neither works nor projects light to the backside of the light-permeable reflective glass 11. Thus, the light-permeable reflective glass 11 functions like the conventional back mirror and reflects the picture of the rear side. When the vehicle turns left or right, or when the driver turns on the setting switch 24 in driving the vehicle straight ahead, the liquid crystal display 12, infrared wide-angle camera 13 and detector 14 are turned on. When the liquid crystal display 12 is turned on, the light thereof penetrates the light-permeable reflective glass 11 and presents the physical image of the corresponding rear side on the light-permeable reflective glass 11, and the driver can thus directly observe the status of the corresponding rear side. At the same time, the detector 14 performs detection and sends a detection signal to the single-chip microprocessor 21. When an object approaches the vehicle, the single-chip microprocessor 21 receives and verifies the signal. If it is an abnormal state, the single-chip microprocessor 21 triggers the first light-emitting devices 15 to warn the external object and also triggers the sound-emitting device 22 the second light-emitting device 23 to warn the driver. Thus is promoted driving safety.

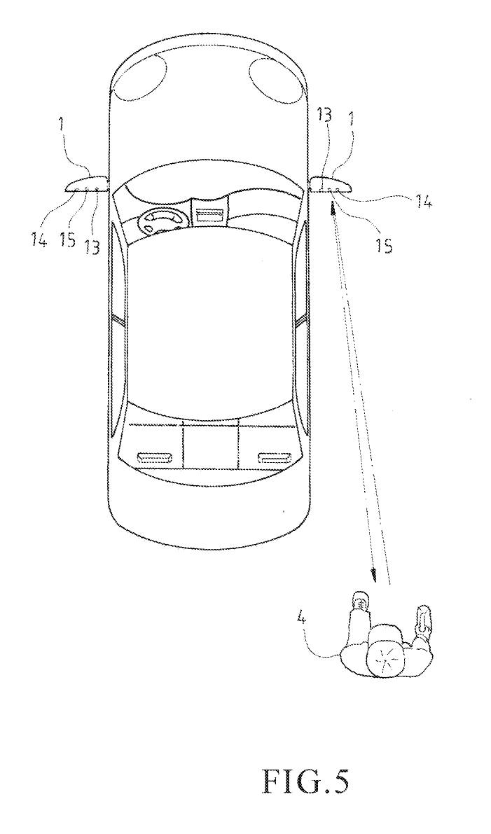

Refer to FIG. 4 an assembly drawing of a back mirror according to one embodiment of the present invention. The control circuit 2 is arranged inside a vehicle 3, and the cables of the components of the left and right back mirrors of the present invention pass through the vehicle body and electrically connect with the control circuit 2. Thereby, the driver can control the components of the left and right back mirrors to perform image-capture, detection and warning and observes the images of the left and right rear sides from the left and right back mirrors.

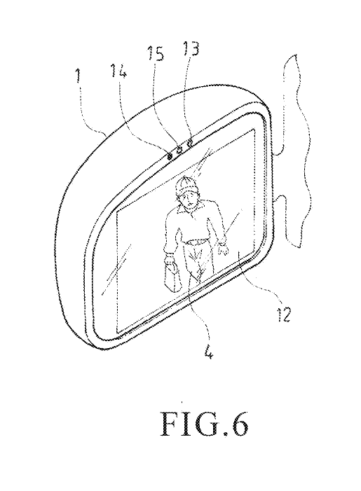

Refer to FIG. 5 and FIG. 6 diagrams schematically showing the operations of a back mirror according to one embodiment of the present invention, and refer to FIG. 2 and FIG. 3 again. When the vehicle runs in a normal state, the light-permeable reflective glass 11 functions like the conventional back mirror and reflects the picture of the rear side. When the vehicle turns left or right, or when the driver turns on the setting switch 24 on the control panel in driving the vehicle straight ahead, the liquid crystal display 12, infrared wide-angle camera 13 and detector 14 are turned on. Then, the cameras 13 capture the images of the corresponding rear sides, and the detectors 14 detect an object 4 approaching the vehicle. The liquid crystal displays 12 show the images captured by the cameras 13, and the light of the images penetrates the light-permeable reflective glasses 11. Thus, the physical images of the rear sides are presented on the light-permeable reflective glasses 11, and the driver can directly observe the status of the rear sides. Thereby, the driver can judge the conditions more accurately.

At the same time, the detector 14 detects the movement of the object 4 and sends a detection signal to the single-chip microprocessor 21. The single-chip microprocessor 21 receives and verifies the detection signal. While the object 4 is approaching the vehicle abnormally and within a given distance from the vehicle, the single-chip microprocessor 21 triggers the first light-emitting device 15 to flash to warn the object 4 outside the vehicle. Simultaneously, the single-chip microprocessor 21 also triggers the sound-emitting device 22 to generate sounds (such as Bi-Bi sounds or music) and the second light-emitting device 23 to flash to warn the driver and remind the driver to take a necessary action. Thereby is promoted driving safety.

The embodiments described above are only to exemplify the present invention but not to limit the scope of the present invention. Any equivalent modification or variation according to the spirit of the present invention is to be also included within the scope of the present invention.

In summary, the present invention proposes an electronic infrared wide-angle and safety-promotion external vehicular back mirror, which has a light-permeable reflective glass and a liquid crystal display triggered by the direction light or a setting switch in turning the direction of a vehicle or driving the vehicle straight ahead to present the status of the rear side, and which can detect an abnormality and warn the driver with flashes and sounds, whereby is promoted driving safety. Therefore, the present invention possesses utility, novelty and non-obviousness and meets the condition for a patent. Thus, the Inventor files the application for a patent. It will be appreciated if the patent is approved fast.

What is claimed is:

1. An electronic infrared wide-angle and safety-promotion external vehicular back mirror, comprising
a light-permeable reflective glass arranged inside a casing on a left or right side of a vehicle;
a liquid crystal display attached to a backside of said light-permeable reflective glass;
a miniature infrared wide-angle camera;
a detector;
a first light-emitting device; and
a control circuit arranged inside said vehicle, electrically connected to said liquid crystal display, said camera, said detector and said first light-emitting device, and further electrically connected to a setting switch and a direction light switch originally installed in said vehicle, wherein said infrared wide-angle camera, said detector and said first light-emitting device are arranged at a perimeter of said casing, and wherein when said vehicle runs in a normal state, said light-permeable reflective glass functions like a conventional back mirror and reflects a picture of the rear side, and
wherein when said vehicle turns left or right, or when the driver turns on said setting switch, said liquid crystal display, said infrared wide-angle camera and said detector are turned on, and
wherein said light-permeable reflective glass presents a physical image of the corresponding rear side to the driver, and
wherein when said detector detects that an object is approaching said vehicle abnormally and within a given distance from said vehicle, said first light-emitting device is triggered to flash.

2. The electronic infrared wide-angle and safety-promotion external vehicular back mirror according to claim 1, wherein said control circuit has a single-chip microprocessor electrically connected to said infrared wide-angle camera and said detector; an output terminal of said single-chip microprocessor is electrically connected to said liquid crystal display and said first light-emitting device.

3. The electronic infrared wide-angle and safety-promotion external vehicular back mirror according to claim 1, wherein said control circuit is also electrically connected to a sound-emitting device and a second light-emitting device; said sound-emitting device and said second light-emitting device are arranged inside said vehicle; when said detector detects that an object is approaching said vehicle abnormally and within a given distance from said vehicle, said sound-emitting device and said second light-emitting device respectively emit sounds and flashes to warn the driver.
